(19) United States
(12) Patent Application Publication
(10) Pub. No.: US 2007/0256591 A1
(43) Pub. Date: Nov. 8, 2007

(54) CORROSION INHIBITING INORGANIC COATINGS FOR MAGNESIUM ALLOYS

(76) Inventor: Walter John Simmons, Martinsburg, WV (US)

Correspondence Address: STEPTOE & JOHNSON LLP, 1330 CONNECTICUT AVENUE, N.W., WASHINGTON, DC, 20036, US

(21) Appl. No.: 11/618,684

(22) Filed: Dec. 29, 2006

Related U.S. Application Data
(60) Provisional application No. 60/754,617, filed on Dec. 30, 2005.

(51) Int. Cl. C04B 9/02

(52) U.S. Cl. 106/14.05

(57) ABSTRACT

A process for producing a corrosion-resistant coating on magnesium includes subjecting a magnesium article to a bath of a non-aqueous molten salt without the application of a potential. An aluminum counter electrode may be in contact with the molten salt.

### CROSS-REFERENCE TO RELATED APPLICATION

This application claims the benefit of Provisional Application No. 60/754,617 filed Dec. 30, 2005, the entire contents of which are expressly incorporated herein by reference thereto.

### STATEMENT AS TO RIGHTS TO INVENTIONS MADE UNDER FEDERALLY-SPONSORED RESEARCH AND DEVELOPMENT

This invention was made with government support under grant number DMI-0419282 from the United States National Science Foundation. The government has certain rights in the invention.

### FIELD OF THE INVENTION

The invention relates to corrosion inhibiting inorganic coatings for magnesium alloys. In particular, the invention relates to a method of anodizing magnesium using a molten salt bath.

### BACKGROUND OF THE INVENTION

A major national initiative (United States Automotive Materials Partnership) is directed at reducing vehicle fuel consumption by the introduction of light-weight materials as automotive components. Because of its low density (magnesium weighs only 22% as much as iron and only 64% that of aluminum) magnesium offers the possibility of major reductions in vehicle weight. But the high electrochemical activity of magnesium makes it especially susceptible to damage by corrosion. Corrosion has been a major barrier to the widespread use of magnesium as a structural material. Corrosion of magnesium also is an important barrier to its industrial usage, especially in the transportation industry.

In the coating of magnesium for both aeronautical and motor vehicle applications, weight reduction is very important and vehicle performance, especially mileage, can be improved by weight reduction.

The low density of magnesium alloys combined with their high mechanical strength is the principal driver for their use in engineering applications. Magnesium alloys, however, are especially susceptible to corrosion because of their inherent high electrochemical activity. On the standard electromotive force series, magnesium ranks 42% more active than aluminum and only 12.9% less active than sodium. Considerable effort has been made by magnesium producers to reduce the corrosion of magnesium alloys by reducing the levels of iron, nickel, and copper impurities, all of which are known to increase the corrosion susceptibility of magnesium. Even so, corrosion remains a major deterrent in the application of magnesium alloys. Because of this susceptibility to corrosion, magnesium alloys are normally restricted to mild atmospheric exposure together with the use of organic (paint) coatings and/or anodic coatings to decrease the inherent susceptibility to corrosion damage. Efforts have been made in the past to produce anodic oxide coatings on magnesium in a manner similar to those that have been routinely used for aluminum alloys. While the anodization of aluminum is relatively straight-forward, the anodization of magnesium has presented a much greater technical challenge.

To address this challenge, many attempts have been made using a variety of electrolytes to produce anodic oxide coatings on magnesium. All commercial methods that have been used up to now for the preparation of anodic oxide coatings on magnesium are based on aqueous electrolytes. There are a large number of such processes in which the aqueous solutions are either strongly acidic or strongly alkaline. These methods include the Dow-17 process developed in the 1940's (De Long, H., Method of Electrolytically Coating Magnesium and Its Alloys, in USPT, 1943, Dow Chemical Company, Midland, Mich.), and the so called H.A.E. (hot-alkaline electrolyte) process which was developed in the early 1950's (Evangelides, H. A., Modern Metals, 1951. 7(4): p. 36). The coatings produced using these commercial processes are typically very thin even though voltages over 100 volts have been employed. Additionally, the bath temperatures used in aqueous acid and alkaline coating anodization methods (100° F. to 180° F.) result in substantial evaporation and produce toxic vapors. See Plunkett, E. R., Handbook of Industrial Toxicology. 1987, New York. Currently available inorganic anodic coatings for magnesium can serve as a base for organic paint coatings but are known to be, by themselves, relatively ineffective at preventing corrosion in moist environments that contain salt, e.g. seacoast regions or winter highways that have been treated with salt to prevent highway surface ice formation. See Uhlig, H., ed., The Corrosion Handbook, John Wiley and Sons, New York, 1948, p. 857.

Molten-salts have long been used in the electrolytic production of magnesium metal by the electrolysis of MgCl₂, which typically requires temperatures of ˜700° C.

There remains a need for a magnesium coating method in which electrolytes used to prepare the coating are environmentally benign and do not have the waste disposal problems associated with current acid and alkaline anodic coating methods. There also remains a need for a coating that is extremely adherent and also effective in preventing the corrosion of magnesium (as well as offering an excellent surface for paint application), so as to advance the use of magnesium alloys in a variety of transportation and other applications. There further exists a need for a class of corrosion inhibiting coatings for magnesium alloys that would permit such alloys to be used in applications that advance the national effort to reduce vehicle weight and, at the same time, increase vehicle efficiency.

### SUMMARY OF THE INVENTION

The invention relates to a class of anodized coatings, produced by a molten-salt process, for corrosion protection of magnesium alloys. The coatings are generated using low temperature, non-aqueous molten-salt electrolytes and greatly increase the resistance of magnesium alloys to corrosion. This process is environmentally benign as well as cheaper and easier than existing hot alkaline or acid anodization methods, both of which present hazardous materials disposal problems. The commercial development of this magnesium coating technology may contribute toward increasing the use of light-weight magnesium alloy automotive components as part of the national effort (United Sates Automotive Materials Partnership) to reduce vehicle weight and increase vehicle mileage.

The coatings of the present invention can be produced on magnesium using a low temperature molten-salt process. The inventive coating technique, combined with the incorporation of inhibiting agents into the adherent oxide produced by the molten-salt bath, provides substantial corrosion resistance/inhibition. In studying the electrochemistry of this process, it has been discovered that at higher molten-salt bath temperatures (220° C. or above) the protective coating forms without the need for any applied anodic current. This discovery is important in the practical, industrial application of this method since it eliminates the need for electrical contact during the coating process, thereby greatly lowering process cost. The coating structure and the overall effectiveness of these coatings in preventing corrosion have been evaluated using the linear polarization method of corrosion evaluation as well as direct accelerated corrosion tests. It has been found that the coating produced by the molten-salt process, especially when given a post-formation secondary chromate treatment, provides an order-of-magnitude increase in corrosion resistance to the base magnesium alloy. The molten-salt method that has been developed appears to offer an entirely new class of coatings for the corrosion protection of magnesium, greatly expanding magnesium's usefulness as an engineering material.

The non-toxic nature of the molten-salts used (they are mixtures of simple nitrates and hence can be disposed of as fertilizer) represents a major advance compared to the toxic acid and alkali aqueous methods currently used to produce anodic coating on magnesium alloys. The baths used to produce existing magnesium coating methods require disposal as hazardous materials.

Thus, the invention relates to a process for producing a corrosion-resistant coating on magnesium that includes subjecting a magnesium article to a bath of a non-aqueous molten salt without the application of a potential. An aluminum counter electrode may be in contact with the molten salt.

### BRIEF DESCRIPTION OF THE FIGURES

Preferred features of the present invention are disclosed in the accompanying figures, wherein:

FIG. 1 shows a scanning electron micrograph of an anodic oxide coating produced by the H.A.E. process (taken at approximately 250×);

FIG. 2 shows a scanning electron micrograph of an anodic oxide coating produced by the Dow-17 process (taken at approximately 250×);

FIG. 3 shows a scanning electron micrograph of an anodic coating produced by the molten-salt electrolyte process of the present invention (taken at approximately 250×); and

FIG. 4 shows a scanning electron micrograph of an anodic coating produced by the molten-salt electrolyte process of the present invention (2748×) for a sample prepared without applied current.

### DETAILED DESCRIPTION OF THE PREFERRED EMBODIMENTS

As used herein, the term “non-aqueous” means less than 0.5 wt % of water.

Five areas addressed herein are summarized as follows:

1. The Determination of the Electrochemical Potentials of Magnesium in Eutectic Molten-Salts as a Function of Temperature:

The electrochemistry of magnesium in oxidizing nitrate molten-salts has been uninvestigated up to now. In connection with the present invention, the rest potential of magnesium alloy AZ 231 B has been determined with reference to a pure gold reference electrode. Magnesium alloy AZ 231 B has the following composition:
Aluminum 2.5 to 3.5 wt %
Zinc 0.6 to 1.4 wt %
Silicon 0.1 wt % max.
Nickel 0.005 wt % max.
Manganese 0.2 wt % min.
Copper 0.005 wt % max.
Iron 0.005 wt % max.
Magnesium—remainder.
   In preliminary work, an iridium reference was used, but it was discovered that iridium is not stable over time in molten nitrate baths. Iridium can be oxidized to IrO₂. This baseline electrochemical potential data is a necessary part of the understanding of the voltages required in the molten nitrate anodization process.

2. The Relationship of Coating Structure and Properties to the Applied Current, Applied Potential and the Salt-Bath Temperature:

The baseline relationships between process parameters and resultant coating properties have been evaluated in order to provide a technological basis for this new coating method. The understanding of these relationships is critical in the eventual production of different types (thickness, porosity, structure) of coatings for different customer needs.

3. The Incorporation of Corrosion Inhibiting Agents by Anodic Coatings:

Because of the non-aqueous nature of this process, it is expected that coatings produced by the molten-salt method will have an increased ability to retain aqueous corrosion inhibitors since the coating, as formed, is entirely desiccated. A coating's ability to retain corrosion inhibitors plays an important part in determining the environment in which these coatings can be used effectively.

4. The Determination of the Quantitative Effectiveness of these Coatings in Preventing and Inhibiting Corrosion:

In connection with the present invention, the quantitative effectiveness of magnesium with molten-salt produced coatings in preventing/inhibiting corrosion has been investigated. The ability to prevent and inhibit corrosion is critical to the determination of the technical utility, commercial feasibility, and the environments in which these coatings could be used.

5. The Preliminary Evaluation of the Industrial Applicability Associated with Applying Anodic Coatings Using Molten-Salt Electrolytes:

Once the effectiveness and the process of producing these new coatings has been shown, industrial applicability will be reviewed. Coating effectiveness, coating cost estimates, scale-up issues, and the ability to meet current and future coating needs have been evaluated in determining a path forward for commercial application.

The electrochemical treatment of magnesium in oxidizing molten-salt nitrate-based eutectics (˜200° C.) can produce anodic oxide coatings, rather than reducing magnesium oxide, due to the strong oxidizing power of such baths. To keep the operating temperature low, a eutectic mixture of potassium nitrate/sodium nitrite has been selected since this system has the eutectic temperature of approximately 150° C. See Uhlig, H., ed., The Corrosion Handbook, John Wiley and Sons, New York, 1948, p. 857. This eutectic temperature is easily producible, and the hot bath does not produce toxic vapors. The non-aqueous method for producing anodic oxide coatings on magnesium according to the present invention involves electrochemistry as described further herein.

Especially important is the discovery that at elevated bath temperatures no applied anodic current is necessary to produce coatings. This discovery is important in that it significantly lowers production costs and consequently will thus contribute greatly to the commercialization of this new magnesium coating process.

The melt compositions (mixed nitrates) for these eutectic molten-salts are environmentally benign and do not represent the environmental hazard that current aqueous acid electrolytes do. There is a large and growing demand for the use of magnesium alloys in vehicle construction to reduce vehicle weight and concomitantly increase vehicle mileage.

Measuring the Basic Electrochemical Potential Versus Temperature Behavior of Magnesium in Oxidizing Molten Nitrate Eutectics

Electrochemical techniques in aqueous solutions have been highly developed over more than a century. Electrochemistry as it occurs under molten-salt conditions has been studied to a far lesser extent. Because anodization is an electrochemical process, it was necessary to establish the basic potential-temperature relationships for magnesium in the molten eutectic salt environment in which the anodization is carried out. To accomplish this a reference electrode is needed. Initially, iridium was used for this purpose. However, the oxidizing power of molten nitrate baths is so great that iridium was found not to exhibit a stable potential due presumably to the formation of iridium oxide. Therefore, a pure gold reference electrode was substituted. Using this reference electrode, Table I gives the measured electrochemical rest potentials for the high strength magnesium alloy AZ 231 B as a function of temperature in a molten eutectic bath of KNO₃—NaNO₂. Table I shows the rest potential of AZ 231 B as a function of temperature in a molten bath of KNO₃ (55 mole %)-NaNO₂ (mole %) as measured against a pure gold reference electrode. At 220° C. the specimens were discovered to form an oxide coating without the need for an external current.

TABLE I

| | T = (° C.) | | | | |
|---|---|---|---|---|---|
| | 170 | 190 | 200 | 220 | 240 |
| V = (volts) | 1.133 | 1.223 | 1.324 | 1.352 | 1.374 |

One important finding of these electrochemical measurements is the discovery that at temperatures above 220° C. the reactivity of the magnesium and the oxidizing power of the melt are so great that an anodized coating is found to form even without the application of any electric current. From the industrial point of view this discovery is especially important since the elimination of the need to apply an electric current to each part that is to be anodized will greatly lower the production cost. In particular, it can be expected to make the production cost of protective coating produced by this new nitrate bath process lower than the costs of existing processes which require the application of a current from an external source.

Preparation of Anodic Coatings on Magnesium and Magnesium Alloys

Classically, anodization requires the application of either constant currents or constant potentials to the metal to be oxidized (anodized). For this purpose both counter electrodes (for use in application of current to the metal) and reference electrodes (for use in measuring the sample potential) are required. Aluminum is an effective counter electrode material for use in the eutectic KNO₃—NaNO₂ mixtures for anodization of magnesium. With the work piece (the magnesium to be anodized) acting as the working electrode, standard polarization methods were initially used to prepare anodized coatings on magnesium via molten-salt electrolytes.

The typical anodic coating procedure was as follows:
1. Reverse polarity (sample negative, molten salt pot positive) was used initially to clean the sample. Typical reverse voltage time was 10 minutes.
2. After 10 minutes of reverse polarity samples were polarized positive for 30 seconds followed by 5 seconds of negative polarity. Coating times were varied between 1 and 4 hours. The current was varied from 0.05 to 1.0 amps (0.025 to 0.5 amps per square inch). Maximum voltage was 4 volts. At currents above 0.2 amps (0.1 amps per square inch) 0.005″ deep pits were noted in the sample. Additionally high amperage coatings contained large flakes with poor adhesion.

The discovery, made as part of the basic electrochemical investigation, i.e. that the coatings could be produced by simple exposure to the molten-salt bath at temperatures above 220° C., allows the formation of coatings with or without an applied current. There is no apparent difference in the coatings produced by the use of low temperature molten baths with applied current anodization or those coatings produced by elevated temperature molten-salt bath exposure alone. This result is understandable since the effect of voltage is to increase the anodic electrochemical potential of the metal until the oxidation potential is high enough to form the oxide. As seen from the electrochemical measurements, the electrochemical potential increases strongly with the bath temperature until at above 220° C., an applied current is no longer needed to oxidize (anodize) the magnesium. Indeed, even at lower bath temperatures, the applied voltages needed to form coatings are very low (less than 12 volts) as compared to the much higher voltages (100 volts) that can be required for existing aqueous coating methods. The high voltages used for these aqueous methods represent a safety hazard and also increase the chance of arcing, with resulting product damage and loss of production.

Characterization of Molten-Salt Produced Anodic Coatings

The coatings produced by molten-salt anodization have been characterized by several different techniques including: optical microscopy, scanning electron microscopy, x-ray diffraction, and abrasion testing.

Optical microscopy was used to assess overall coating consistency and uniformity. Such direct examination of the coatings showed that for thin coatings, pinholes can be present, but as the coatings thicken and as the temperature increases pinholes are no longer a problem. Furthermore, with the use of high temperature (above 220° C.) baths, the coating can be made arbitrarily thick by increasing the bath temperature and the exposure time. These coatings are found to be extremely adherent, so much so that the samples could be bent 180 degrees without breakage or release of the film.

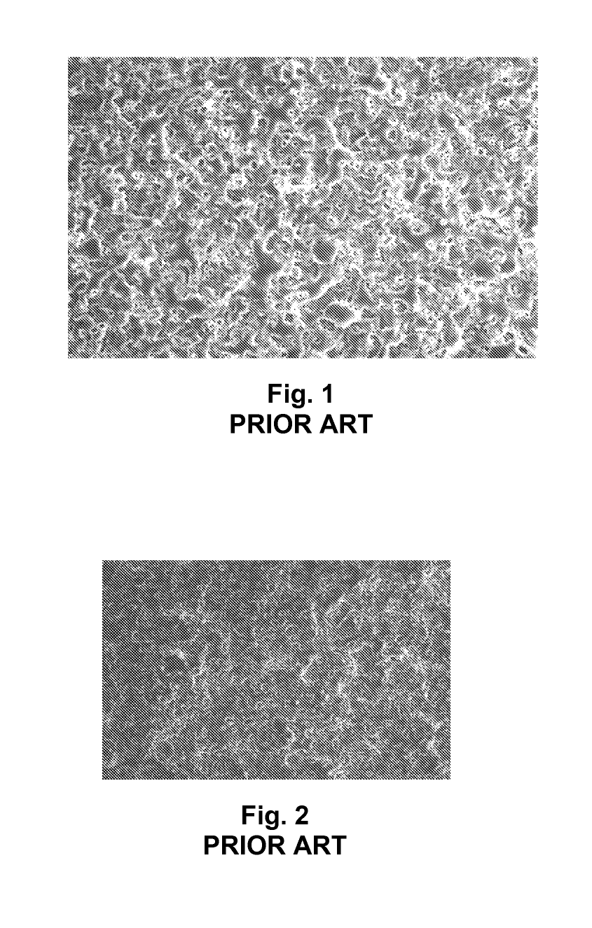

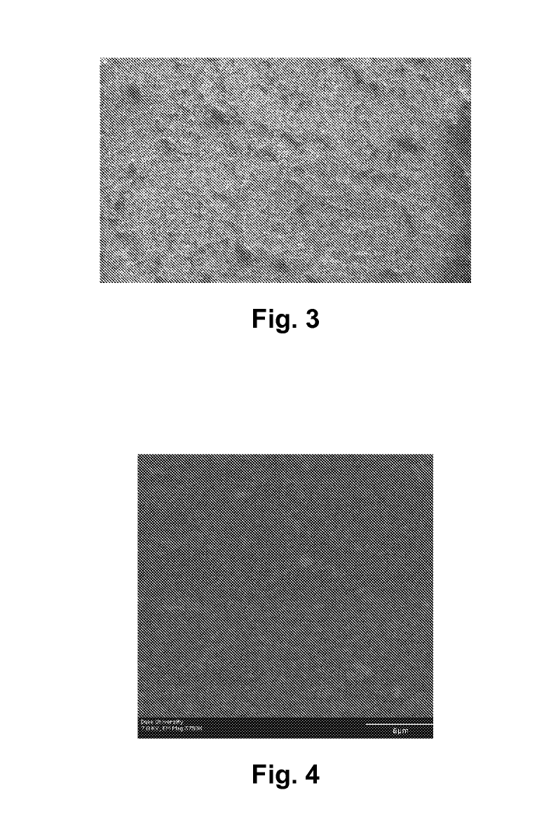

Scanning electron microscopy was used to examine the coatings produced by this new molten-salt process, and FIGS. 1-2 show the structure of both commercial H.A.E. and Dow-17 coatings, respectively, as compared to the coating produced by this molten-salt process as shown in FIGS. 3-4.

Coatings produced using molten-salt electrolytes have an entirely different physical structure than those produced by the Dow-17 or H.A.E processes. Electron micrographs of the H.A.E and Dow-17 produced coatings are shown in FIGS. 1 and 2. The coating produced by the molten-salt process of the present invention are shown in FIGS. 3 and 4. As may be seen in these micrographs the structure of the coating produced by molten-salt anodization of magnesium is vastly different from the structures produced by either the acid electrolyte (Dow-17) or the alkaline electrolyte processes (H.A.E.). In particular, although the anodic coating produced in molten-salt still shows micro porosity, its microstructure is substantially finer than either of the other processes. X-ray diffraction evaluation using Cu-Kα radiation has revealed that the molten-salt produced coating is either amorphous or has a crystalline structure finer than 10 nm, as discussed below.

X-ray diffraction has been used in an attempt to determine the crystalline/amorphous structure of the coatings. However, no diffraction spectrum from the coatings was found, indicating that they are either amorphous or else nanocrystalline in nature. In x-ray diffraction, when the diffracting crystalline elements become less than about 5 nanometers in size the diffraction patterns become so broadened that diffraction peaks are no longer distinguishable in the resulting diffraction spectrum. Evaluation of the intrinsic coating stress state via Warren-Averback analysis is therefore not possible for this case.

Corrosion Inhibitor Incorporation into Molten-Salt Prepared Coatings

The current standard inhibiting agents for corrosion reduction of magnesium are chromates. One important factor in developing corrosion protection via anodized coatings is the ability of such coatings to take-up and retain the corrosion inhibiting agent. We have found that anodic coatings produced via a non-aqueous process have a marked ability to take-up and to retain chromate inhibitors from aqueous solutions. This improvement may be due to the fact that that the aqueous adsorption sites on such coatings will not be as fully occupied when produced under non-aqueous conditions as they are when coatings are produced by aqueous processes. In any event, a chemical impregnation procedure has been developed to maximize the deposition of sparingly soluble chromate salts within the body of the coating. This result has been achieved by an impregnation procedure of the present invention. It is desirable that the final chromate compound that is deposited within the coating be only sparingly soluble in order that it not be rapidly leached away during exposure to corrosion-inducing environments. On the other hand, some solubility is necessary in order that chromate ions be produced in order to adsorb onto the metal surface. Zinc chromate is ideally suited to this application, but since it has a low solubility it cannot be added directly to the coating. Instead the sample is first exposed for 30 minutes to a solution of zinc sulfate, which is very soluble, after which the sample is then immediately exposed to a solution of sodium dichromate, which is also very soluble. In the first bath, the porous anhydrous coating is saturated with the zinc sulfate. In the second impregnation bath, the zinc chromate precipitates out in situ within the body of the coating. Additionally, there are some reports in the literature that exposure of magnesium to NaF solutions can improve corrosion performance through the formation of a thin MgF layer. Both NaF and zinc chromate additions to anodized samples were evaluated by the linear polarization corrosion testing method as described below.

Proof Testing of Corrosion Inhibition

The Stern-Geary electrochemical method of measuring corrosion determines the overall corrosion current using polarization of test specimens to which are applied small and measured anodic currents around their corrosion potential. As shown by Stern and Geary (Stern, M., and Geary, A. L., Journal of the Electrochemical Society, vol. 104, p. 139t, 1957) the corrosion rate can then be determined by the relation:

$${I}_{corr} = \frac{{I}_{appl}}{2.3 Δϕ} ( \frac{{β}_{c} {β}_{a}}{{β}_{c} + {β}_{a}} )$$

The ratio Iₐₚₚ/Δφ has the units of resistance (ohms) and is termed the polarization resistance. When the applied current is given in units of current density (amps/cm²), the polarization resistance has the units of ohm-cm² and is proportional to the corrosion rate per unit area. The constants βₐ and β_{c} refer to Tafel constants for the cathodic and anodic reactions respectively, and Iₐₚₚ/Δ_{φ} is the polarization slope in the linear region around the corrosion potential. These Tafel constants are fundamental properties and can be approximated as a practical matter by βₐ=β_{c}=0.1 within experimental error. The shift in potential Δφ for very small (less than 10 mV anodic and 10 mV cathodic) polarizations is caused by very small applied currents (Iₐₚₚₗ). I_{corr} as measured by this procedure represents the average overall corrosion rate for the sample for which the polarization is taken.

To carry out this test, bare specimens, specimens having anodized coatings without chromate, specimens having anodized coatings impregnated with sodium fluoride (to produce a magnesium fluoride layer), specimens impregnated with zinc chromate, and specimens impregnated with both sodium fluoride and zinc chromate, and finally specimens impregnated with sodium fluoride and zinc chromate followed by impregnation with sodium silicate have been tested. The results of these tests are given in Table II, which shows polarization resistance testing of samples of alloy AZ 231 B in aerated 3.5% salt solution. From this Table, it can be seen that the polarization resistance of the coated samples is approximately an order-of-magnitude greater than that of the uncoated samples, which means that the rate of corrosion of the coated samples is only approximately one-tenth that of the uncoated samples. Molten-salt coatings are an excellent base for paint, and such paint coatings would be expected to increase corrosion resistance still further.

TABLE II

| | Polarization resistance |
|---|---|
| Sample Description | (ohms × cm²) |
| Bare | 5.8 +/− 1.0 |
| Anodized | 10.3 +/− 1.5 |
| Anodized with NaF impregnation | 7.4 +/− 0.8 |
| Anodized with zinc chromate impregnation | 48.4 +/− 1.7 |
| Anodized with zinc chromate + NaF | 43.3 +/− 1.2 |

As can be seen, chromate is very effective in increasing the corrosion resistance of the coated specimens, whereas NaF impregnation actually decreased the corrosion resistance of the coated and the chromate impregnated samples. Since the corrosion rate is linearly proportional to the polarization rate, these data show that anodization plus chromate impregnation can increase the corrosion resistance by nearly an order-of-magnitude.

In addition to the Stern-Geary electrochemical corrosion rate test, a modified ASTM copper accelerated acetic acid salt spray fog (CASS) test has been used to evaluate the corrosion resistance properties of coatings produced by novel molten-salt anodization compared to that of uncoated samples.

It is to be noted that the CASS test is considered to be an extremely aggressive corrosion test procedure and is far more corrosive than unmodified salt solutions. The CASS test, because it involves the use of a soluble copper compound (CuCl₂), greatly accelerates corrosion rate due to the exchange precipitation of metallic copper at those regions where magnesium preferably corrodes. These copper metallic precipitates act as cathodes, thereby accelerating the corrosion of any magnesium surface on which they have been deposited, and thus lead to greatly enhanced attack. From a typical result of the CASS testing of both coated and uncoated magnesium alloy samples, it is apparent that, while the coated sample is still somewhat attacked by this very aggressive test, it is also apparent that the uncoated sample is attacked to a far greater extent, thus confirming the ability of the coating to provide substantial protection against corrosive attack. In testing, coated and uncoated specimens were subjected to two weeks of CASS corrosion exposure. The coated sample showed far less corrosive attack than did the uncoated sample, in accordance with the result to be expected from the Stern-Geary polarization resistance corrosion tests.

Commercial Potential—Evaluation of the Industrial Applicability Associated with Applying Anodic Coatings Using Molten-Salt Electrolytes and the Path to Commercialization

The discovery that an applied current is not required in order to produce coatings if the bath temperature is above 220° C., together with the environmentally benign nature of the molten baths make this new method much cheaper and easier to use than the hot alkaline and acid bath methods currently known. The corrosion-protective ability of the coating produced by the molten-salt process has been demonstrated, along with the remarkable physical adhesion properties of the coating. The ability of these coatings to serve as an effective base for paint has also been demonstrated.

The market for a new and improved protective coating on magnesium alloys consists of all current users of magnesium alloys. Currently the largest tonnage of magnesium alloy products consists of specific vehicle parts, such as: instrument panel beams, seat assemblies, steering column brackets, petal brackets, roof frames, valve/cam covers, transfer cases, door frames, tail gates, seat risers, seat pans, consol brackets, key lock housings, glove box doors, widow motor housings, clutch housings, oil pans, alternator brackets, transmission stators, fuel filter lids, and brake pedal arms. Reviews of potential and current applications have recently been published. See Lou, A., “Magnesium: Current and Potential Automotive Applications,” Journal of Metals, vol. 54(2), pp. 42-48, 2002. Currently American auto producers consume magnesium products in excess of 40,000 tons/year and consumption is increasing at more than 6% per annum. All of these parts would benefit from increased corrosion protection, and thus all of these producers would be potential customers. The competition for the process of the present invention is principally the Dow-17 and the H.A.E processes, both of which were developed more than 50 years ago. There are a large number of commercial coaters who use either or both of these processes. In profile all of these operations tend to be of small to modest size and typically function as suppliers to vehicle manufacturers. In addition magnesium is extensively used in military vehicles, and the coating of their magnesium parts also represents a potential market.

Substantial progress has been made in the development and testing of this new process for preparing anodic oxide coatings on magnesium by means of a new molten-salt method. In particular, it has been discovered that at elevated bath temperature, the oxidizing power of the bath is increased sufficiently by temperature alone that an applied current is not needed in order to produce an oxide coating on magnesium. The total elimination of the need to make electrical contact with and apply current to each component to be coated greatly simplifies the industrial application of this new magnesium coating process as well as lowering its cost.

Thus, extremely adherent coatings have been produced on magnesium through the use of molten-salt baths either with or, at elevated bath temperatures, without an applied anodic current. Furthermore these coatings have been shown to provide very substantial corrosion protection, even under aggressive corrosion conditions. The adherence of these coatings is so great that the test samples can be bent into a tight U-shape without detachment of the coating. After testing a series of inhibitor impregnation techniques, a procedure and method for the impregnation of these coatings has been developed that confers an order-of-magnitude increase in corrosion resistance. These coatings also provide an excellent base for the application of paint or other organic final coatings. As a result of the tenacious adherence of the coatings produced by this molten-process, plus their ability to incorporate corrosion inhibiting compounds and the ability of the coating itself to inhibit corrosion, together with the environmentally benign nature of the eutectic molten-salt baths used to produce them, this new magnesium coating technique appears to be a major and industrially important development in magnesium technology.

In some embodiments of the present invention, water may be added to the molten salt bath. For example, water may be added in the ratio of 1 gram of water to 500 grams of molten salt bath such as the eutectic KNO3- NaNO₂ mixtures.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A process for producing a corrosion-resistant coating on magnesium comprising:
subjecting a magnesium article to a bath of a non-aqueous molten salt without the application of a potential.

2. The process of claim 1, wherein an aluminum counter electrode is in contact with the molten salt.
